(19) United States
(12) Patent Application Publication
(10) Pub. No.: US 2015/0187373 A1
(43) Pub. Date: Jul. 2, 2015

(54) Method for Fabricating a Magnetic Assembly Having Side Shields

(71) Applicant: Seagate Technology LLC, Cupertino, CA (US)

(72) Inventors: Denis O'Donnell, Culmore (GB); John Rooney, Letterkenny (IE); Thomas McLaughlin, Enagh (GB)

(21) Appl. No.: 14/140,815

(22) Filed: Dec. 26, 2013

(51) Int. Cl. G11B 5/11

(52) U.S. Cl. CPC G11B 5/112

(57) ABSTRACT

Methods for fabricating a shield structure for a pole tip of a write element for magnetic recording are disclosed. In illustrated embodiments disclosed, a side shield deposition is etched below a front edge surface of the pole tip and one or more depositions are deposited on the etched side shield deposition to form a side shield structure having an extended gap region to enhance performance of the write element. In illustrated embodiments, multiple gap depositions are deposited to form the extended gap region and side shield structure. One or both of the multiple gap depositions are etched to remove outer portions of the deposition prior to depositing the front shield structure.

### SUMMARY

The present application discloses methods for fabricating a shield structure for a pole tip of a write element for magnetic recording. In illustrated embodiments disclosed, a side shield deposition is etched below a front edge surface of the pole tip and one or more depositions are deposited on the etched side shield deposition to form a side shield structure having an extended gap region to enhance performance of the write element. In illustrated embodiments, multiple gap depositions are deposited to form the extended gap region and side shield structure. One or both of the multiple gap depositions are etched to remove outer portions of the deposition(s) to form the extended gap region prior to depositing the front shield structure. Other features and benefits that characterize embodiments of the present invention will be apparent upon reading the following detailed description and review of the associated drawings.

### BRIEF DESCRIPTION OF THE DRAWINGS

FIG. 1 is a schematic illustration of a wafer fabrication sequence for heads of a data storage device.

FIG. 2A is a detailed illustration of a write element shown in cross-section to illustrate a main pole and one or more return poles.

FIG. 2B is a detailed illustration of a pole tip and shield structure for the pole tip shown in FIG. 2A as viewed from an air bearing surface of the head.

FIG. 3A is a flow chart illustrating processing steps for fabricating a write pole and write pole shield structure.

FIG. 3B illustrates an embodiment of a process sequence for fabricating a write pole shield structure utilizing the processing steps illustrated in FIG. 3A.

FIG. 3C illustrates another embodiment of a process sequence for fabricating a write pole shield structure utilizing the processing steps illustrated in FIG. 3A.

FIG. 4A is a flow chart illustrating processing steps for fabricating a write pole and write pole shield structure according to another embodiment.

FIG. 4B illustrates an embodiment of a process sequence for fabricating a write pole shield structure utilizing the processing steps illustrated in FIG. 4A.

FIG. 4C illustrates another embodiment of a process sequence for fabricating a write pole shield structure utilizing the processing steps illustrated in FIG. 4A.

FIG. 5A is a flow chart illustrating processing steps for fabricating a write pole and write pole shield structure according to another embodiment.

FIG. 5B illustrates an embodiment of a process sequence for fabricating a write pole shield structure utilizing the processing steps illustrated in FIG. 5A.

FIG. 5C illustrates another embodiment of a process sequence for fabricating a write pole shield structure utilizing the processing steps illustrated in FIG. 5A.

FIG. 6A is a flow chart illustrating processing steps for fabricating a write pole and write pole shield structure and gap region having a graded or variable material composition to optimize shielding and field gradient.

FIG. 6B illustrates an embodiment for depositing one or more gap layers to form a graded gap region as described in FIG. 6A.

FIG. 6C illustrates another embodiment for fabricating a graded gap region described in FIG. 6A.

### DETAILED DESCRIPTION OF ILLUSTRATIVE EMBODIMENTS

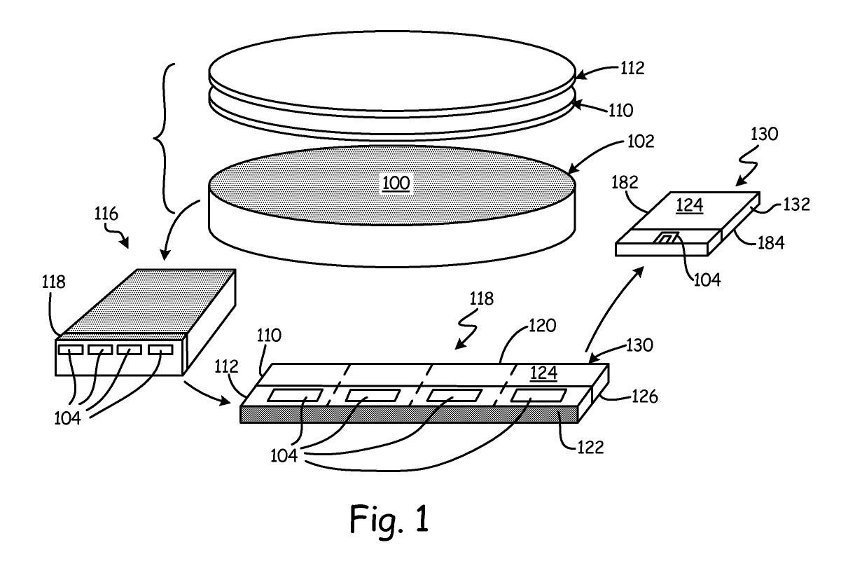

The present application relates to processing methods for fabricating heads to optimize a gap region between a write pole and shield structure for the pole tip of a write element. The processing methods described optimize the gap region and the shield structure to enhance performance. The disclosed methods utilize wafer fabrication and deposition techniques. As shown in FIG. 1, multiple thin film deposition layers are deposited on a surface 100 of a wafer or substrate 102 to form one or more transducer elements 104 (illustrated schematically in FIG. 1). As shown, the multiple deposition layers include one or more read element layers 110 and write element layers 112. The read and write element layers 110, 112 are illustrated schematically in FIG. 1. Following deposition of the read and write element layers 110, 112, the wafer 102 is sliced into a bar chunk 116. The bar chunk 116 includes a plurality of slider bars 118 (one slider bar 118 is shown exploded from the chunk 116).

The sliced bars 118 have a leading edge 120, a trailing edge 122, air bearing surface 124 and a back surface 126. After the bars 118 are sliced from chunks 116, the transducer elements 104 (read and write elements) deposited on the wafer 102 are orientated along the air bearing surface(s) 124 at the trailing edge 122 of the slider bar 118. The slider bar 118 is sliced to form the heads 130. Typically, the bar 118 is lapped and the air bearing surface(s) 124 are etched prior to slicing the bar 118 to form the individual heads 130. Illustratively, the wafer 102 is formed of a ceramic material such as Alumina (Al₂O₃)—Titanium Carbide (Ti—C) and the read and write elements are fabricated on the ceramic or substrate material of the wafer 102 to form a slider body 132 of the head and the one or more deposition layers 110, 112 form the transducer elements 104 along the trailing edge 122 of the slider body 132.

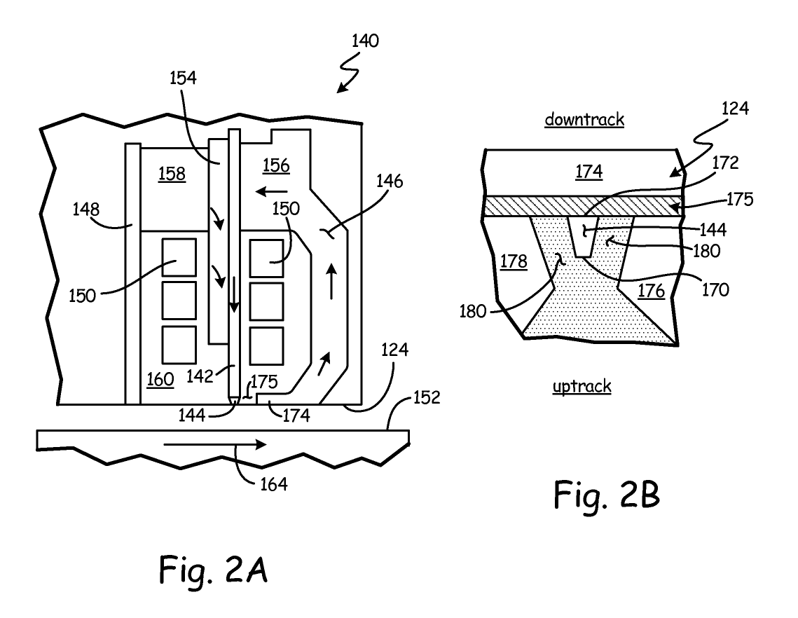

FIGS. 2A-2B illustrate an embodiment of a write element 140 for the magnetic head 130 fabricated from the write deposition layers 112. As shown in FIG. 2A, the write element 140 includes a main pole 142 having a pole tip 144, a top return pole 146, a bottom return pole 148 and a coil 150 to induce a magnetic flux path through the write pole 142 to record data on a magnetic recording media 152. The main pole 142 is coupled to a yoke 154 and is connected to the top return pole 146 and bottom return pole 148 through top and bottom back vias 156, 158. The coil 150 and poles 142, 146, 148 are encapsulated in an insulating structure 160. Reference to top and bottom refers to an order of deposition of a bottom pole structure and top pole structure to form the bottom and top return poles 146, 148. Application of the illustrated embodiments is not limited to the write element 140 including both a top return pole and a bottom return pole and the write element 140 can include one or both of the top and bottom return poles 146, 148.

As schematically illustrated in FIG. 2A, the recording media 152 rotates in direction as illustrated by arrow 164 to sequentially record data bits to one or more magnetic layers (not shown) on the media 152. In the illustrated embodiment, the write element 140 is configured to perpendicularly record data to the one or more magnetic layers of the media 152. In particular, current is applied to the coil 150 to induce the magnetic flux path through the main pole 142 and the return poles 146, 148 to record data in an up/down orientation relative to the media 152. As shown in FIG. 2B, the pole tip 144 is formed along the air bearing surface 124 of the head 130 to induce the perpendicular field in the one or more of the magnetic layers of the media 152. The direction of the current is varied to vary the direction of the flux path to perpendicularly record data to the media 152.

Rotation of the media 152 for read/write operations provides an air flow along the air bearing surface 124 of the head 130 to support the head 130 above the media 152. The air flows along the write element 140 from a leading edge 170 of the pole tip 144 to a trailing edge 172 of the pole tip 144 as shown in FIG. 2B. In the illustrated embodiment, the pole tip 144 is tapered to provide a narrow profile at the leading edge 170 compared to a width of the pole tip 144 at the trailing edge 172 to reduce adjacent track interference and compensate for the skew angle of the media 152. As shown in FIGS. 2A-2B, the write element 140 includes a shield structure for the pole tip 144 to limit interference and adjacent track erasure for perpendicular magnetic recording. The shield structure includes a front shield 174 forward or downtrack from the pole tip 144 connected to the top return pole 146. As shown, the front shield 174 is separated from the pole tip 144 via an insulating non-magnetic gap region or write gap 175. The shield structure also includes side shields 176, 178 extending alongside the pole tip 144. In the embodiment illustrated in FIG. 2B, the side shields 176, 178 are separated from the pole tip 144 by an insulating non-magnetic gap region 180 along opposed sides of the pole tip 144. The side shield structure 176, 178 extends from the gap region 180 to opposed sides 182, 184 of the head 130 (shown in FIG. 1).

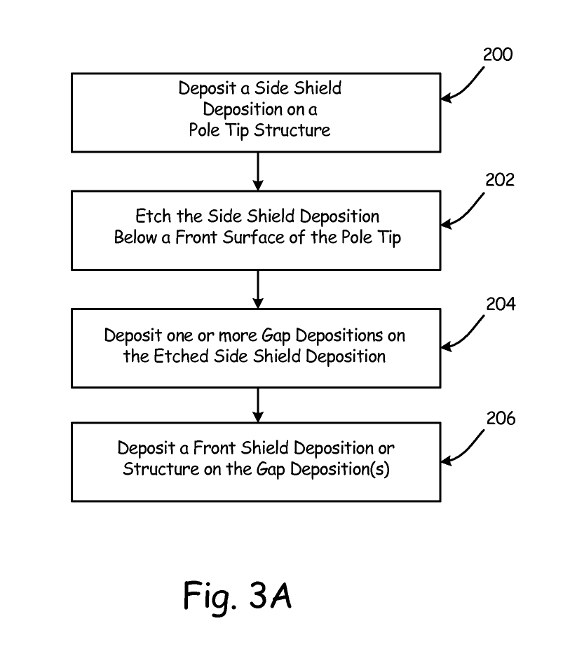

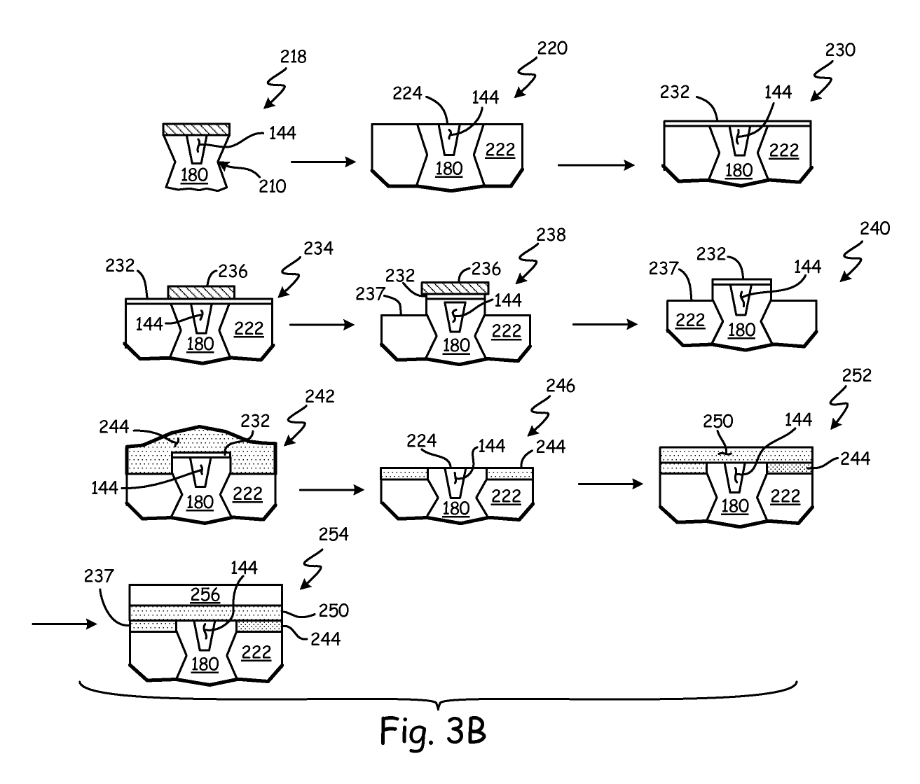

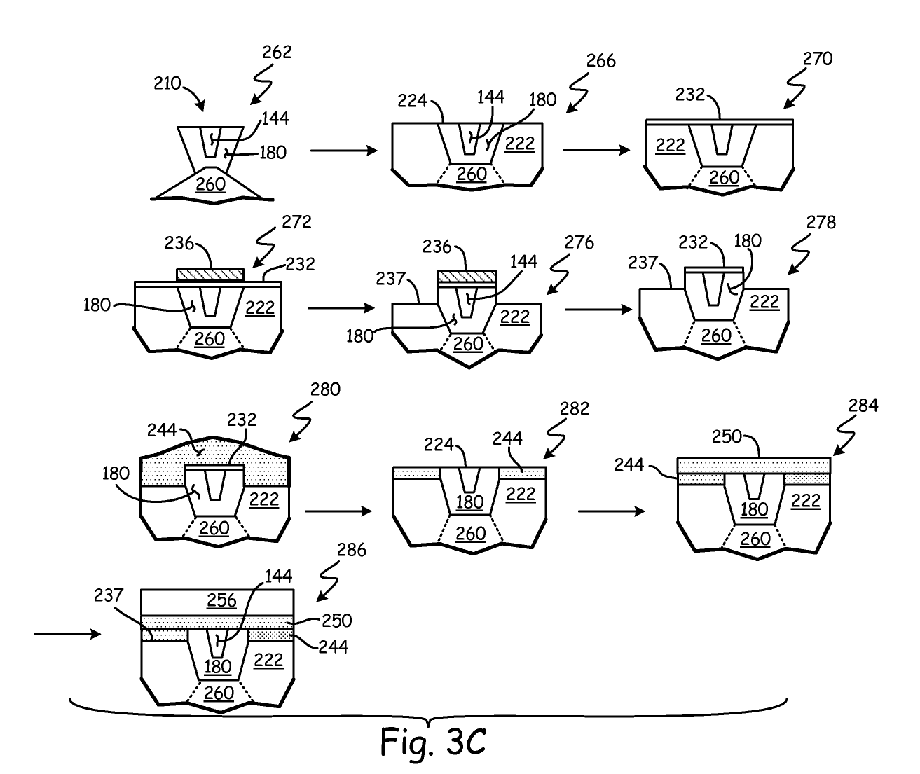

FIG. 3A illustrates multiple process steps for fabricating a shield structure for the pole tip 144 of a write element 140. The steps include depositing a side shield deposition on a pole tip structure as illustrated in step 200. In step 202, the side shield deposition is etched to remove material below a front surface of the pole tip to form a recessed edge surface for the side shield structure 176, 178. In an illustrated embodiment, the deposition is etched using an ion beam milling process. In step 204, one or more gap depositions are deposited on the etched side shield deposition to form the non-magnetic write gap 175 and extended gap region for the pole tip 144. In different embodiments, the one or more gap depositions can comprise the same material or different materials. Thereafter in step 206, a front shield deposition is deposited to form the front shield structure 174 of the write element 140.

FIGS. 3B-3C illustrates different process embodiments utilizing the processing steps described in FIG. 3A. In the illustrated embodiments, the pole tip structure 210 shown in sequence stop 218 is fabricated on top of one or more deposition layers 110 for the read element. In an illustrated embodiment, the pole tip structure 210 is etched from a deposition stack including a pole tip layer and insulating layer using an ion milling process. The deposition stack is ion milled utilizing a mask to form the pole tip structure 210. The ion mill is angled to form a trapezoidal shape pole tip 144. A gap layer is deposited along the sides of the pole tip 144 to form the gap region 180 of the pole tip structure 210. Illustratively, the gap layer is deposited along the upright sides of the pole tip 144 using a conformal deposition technique such as atom layer deposition (ALD) or other conformal deposition technique. In an alternate embodiment, the pole tip 144 and pole tip structure 210 are fabricated utilizing a damascene etching process. In illustrated embodiments, insulating and gap layers are formed of a non-magnetic and electrically insulating material such as Alumina Al₂O₃ and the pole tip 144 is formed of a magnetically permeable material or ferromagnetic material, such as, but not limited to, iron (Fe), cobalt (Co), and nickel (Ni) and combinations thereof.

As shown in sequence step 220, a side shield deposition 222 is deposited along the gap layer of the pole tip structure 210 to form the side shields 176, 178. The deposition 222 is planarized to form a top surface generally co-planar with a front surface 224 of the pole tip 144 at the trailing edge of the pole tip 144. The planarization step utilizes a stop layer (not shown) to control the etched depth. In an illustrated embodiment, the stop layer is deposited on the deposition stack prior to etching the deposition stack to form the pole tip structure 210. The deposition 222 is deposited on the pole tip structure 210 using a conductive seed layer to electro-plate the deposition 222 to the pole tip structure 210. The deposition 222 is planarized utilizing a chemical mechanical polishing (CMP) processing step.

In sequence step 230 shown, a stop layer 232 is deposited on the top surface of the deposition 222. In an illustrated embodiment, the stop layer 232 is a CMP stop layer material to control removal of material during a planarization step. As progressively illustrated in sequence step 234, mask 236 is patterned to etch the side shield deposition 222 below the front surface 224 of the pole tip 144 to form a recessed trailing edge surface 237 uptrack from the trailing edge of the pole tip 144 as illustrated in step 238. In an illustrated embodiment, mask 236 is patterned using a photolithography and etching process, such as an inductively coupled plasma (ICP) etching process.

The side shield deposition 222 is etched using an ion beam etch to etch through the stop layer 232 and a trailing portion of the side shield deposition 222 as shown. As shown, an entire width of the side shield deposition is etched between opposed sides 182, 184 of the head or slider body 132. In the illustrated embodiment, the side shield deposition 222 is etched to a depth proximate to mid-length or mid-height of the pole tip 144. In another illustrated embodiment, the etched depth is about a third of the pole tip 144 height between the leading and trailing edges 170, 172 of the pole tip 144 so that the etched depth is at least a third of the pole tip 144 height. In another embodiment, the etch depth is about three quarters of the pole tip 144 height. In sequence step 240, the mask 236 is removed and in sequence step 242, a first gap deposition 244 is deposited on the etched side shield deposition 222 as shown.

In sequence step 246, the first gap deposition 244 is planarized to remove a portion of the deposition 244 over the front surface 224 of the pole tip 144. In an illustrated embodiment, the deposition 244 is etched or planarized using CMP and the stop layer 232 prevents over-polishing. In particular, the stop layer 232 is used to control the depth of material removed during the planarization process in step 246 to control the removal depth of the gap deposition 244. As shown, the stop layer 232 over the pole region is protected by the mask 236 during the etching step 238. The stop layer 232 is removed by an etching process following the CMP in step 246. A second gap deposition 250 is deposited over the first gap deposition 244 and the pole gap region 180 and planarized to form the write gap 175 forward of the pole tip 144 in step 252. In sequence step 254, a front shield deposition 256 is deposited to form the front shield structure 174 connected to the return pole 144 of the write element 140 as illustrated in FIG. 2A. The process sequence disclosed provides steps for fabrication of a side shield structure having a truncated trailing edge surface 237 spaced uptrack from the trailing edge 172 or front surface 224 of the pole tip 144 and extended gap region between the side shield structure 176, 178 and the front shield structure 174. The truncated side shield structure reduces the flux leakage proximate to the trailing edge 172 of the pole tip 144 to enhance write field gradient and field strength.

The side shield and front shield depositions 222, 256 are formed of the same or similar ferromagnetic materials as the pole tip 144. For example in illustrated embodiments, deposition material for the side and front shields include but is not limited to iron cobalt (CoₓFe_{y}), iron nickel (Fe_{y}Niₓ) or cobalt iron nickel (CoₓFe_{y}Ni_{z}). In one embodiment, both the pole tip 144 and side and front shields 174, 176, 178 are formed of a high magnetic moment alloy. The gap depositions 244, 250 are a non-magnetic insulating material such as Alumina or other ceramic or non-magnetic insulating material.

FIG. 3C illustrates a process sequence similarly incorporating the process steps disclosed in FIG. 3A where like numbers are used to identify like parts in the previous FIGS. In the illustrated embodiment shown in FIG. 3C, the process sequence is used to fabricate a box shield structure. The pole tip structure 210 for the box shield structure is formed from a deposition stack including a bottom shield layer 260 to form a leading shield structure, as well as the insulating layer and pole tip layer. The bottom shield layer 260 is formed of a ferromagnetic material as previously described for the side shield and front shield depositions 222, 256. The gap layer is deposited on the etched deposition stack to form the pole tip structure 210 for the box shield structure including the gap region 180 as shown in sequence step 262. In sequence step 266, the side shield deposition 222 is deposited on the pole tip structure 210 and planarized as previously described. In sequence step 270, the stop layer 232 is deposited on top of the pole tip 144 and the planarized side shield deposition 222.

In sequence step 272, mask 236 is patterned over stop layer 232 along a pole tip region as shown. Thereafter in sequence step 276, the side shield deposition 222 is etched below the front surface 224 of the pole tip 144 so that a top surface of the side shield deposition 222 is recessed below the trailing edge 172 of the pole tip 144 to form the trailing edge surface 237 of the side shield structure uptrack from the trailing edge 172 of the pole tip 144. As previously described in step 278, the mask 236 is removed and in step 280 the first gap deposition 244 is deposited on the etched surfaces. The first gap deposition 244 is planarized in step 282 to remove material above the front surface 224 of the pole tip 144 using a CMP process. As previously described, the stop layer 232 is used to control a planarization depth of the first gap deposition 244 and is etched following CMP as shown in step 282. The second gap deposition 250 is deposited over the first gap deposition 244 and the pole tip region in sequence step 284 and planarized. In sequence step 286, the front shield deposition 256 is deposited over the second gap deposition 250 to form the front shield structure of the write element 140 separated from the pole tip 144 via write gap 175.

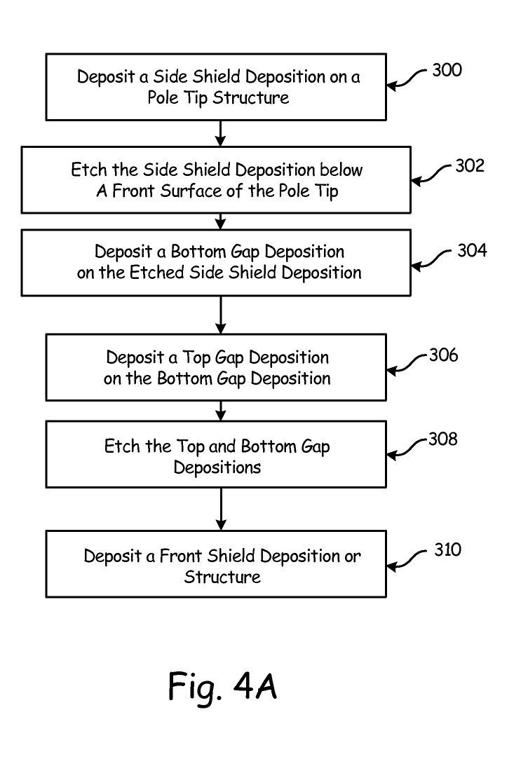

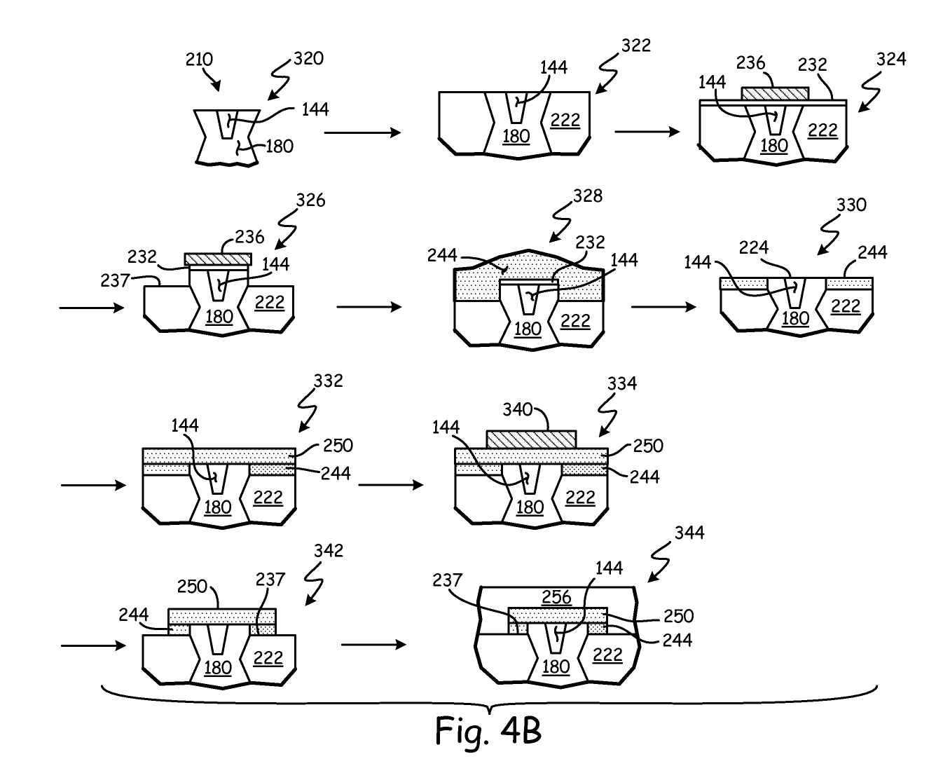

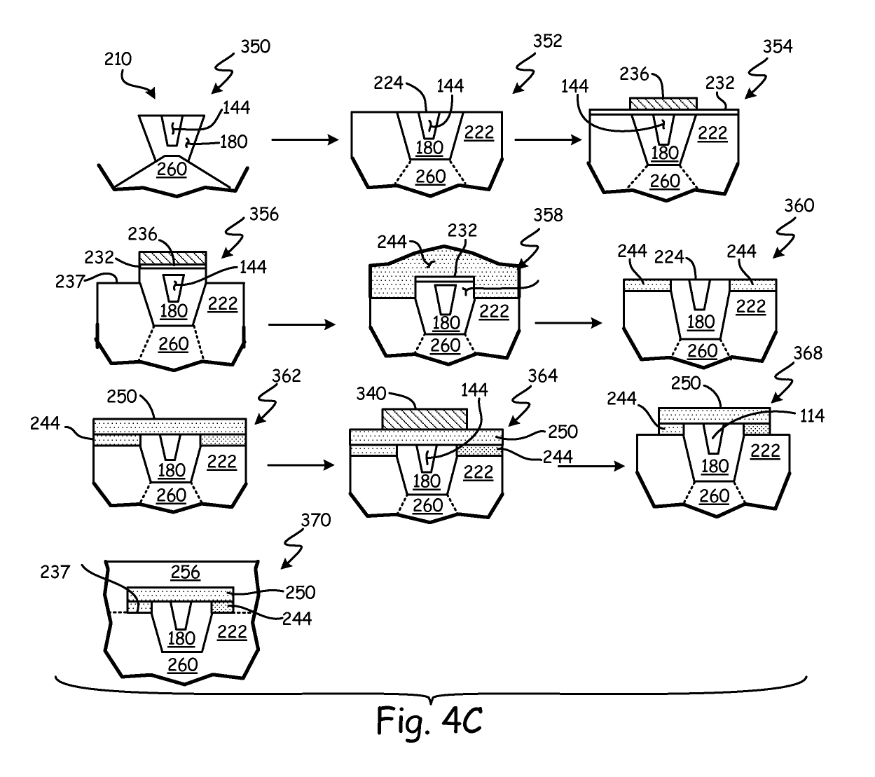

FIG. 4A illustrates another embodiment for fabricating the shield structure for the pole tip 144 of a write element 140. As illustrated in FIG. 4A, in step 300, the side shield deposition 222 is deposited to form the side shield structure on the pole tip structure 210. In step 302, the side shield deposition 222 is etched to form an edge surface recessed below a front surface 224 of the pole tip 144. In step 304, a bottom or first gap deposition 244 is deposited on the etched side shield deposition 222. Thereafter in step 306, a top or second gap deposition 250 is deposited over the first gap deposition 244 forward of the front edge of the pole tip. In step 308, the first and second gap depositions 244, 250 are etched to form the write gap 175 and the extended gap region. Thereafter in step 310, the front shield deposition 256 is deposited over the etched gap depositions 244, 250 to form a top side shield portion and the front shield structure 174 of the write element 140.

FIGS. 4B-4C illustrate embodiments utilizing the process steps disclosed in FIG. 4A where like numbers are used to identify like parts. In the embodiment illustrated in FIG. 4B, a deposition stack is etched using a mask and the gap layer is deposited to form the pole tip structure 210 shown in sequence step 320 as previously described. In sequence step 322, the side shield deposition 222 is deposited on the pole tip structure 210 and planarized. As previously described, the side shield deposition 222 is electro-plated to a seed layer (not shown) deposited on the pole tip structure 210. In sequence step 324, stop layer 232 is deposited and mask 236 is patterned over the stop layer 232 to etch the side shield deposition 222 to form the recessed edge surface 237 uptrack from the front surface 224 of the pole tip 144 as illustrated in sequence step 326. In step 328, the first gap deposition 244 is deposited. The first gap deposition 244 is planarized utilizing the stop layer 232 to control the etched depth as illustrated in sequence step 330 as previously described.

In step 332, the second gap deposition 250 is deposited over the first gap deposition 244 and the pole tip region. In sequence step 334, mask 340 is patterned to etch the first and second gap depositions 244, 250 to form the expanded gap region along a trailing edge portion of the pole tip 144. In an illustrated embodiment, the mask 340 is a patterned resist and the first and second gap depositions 244, 250 are ion milled or etched to remove outer portions of the depositions 244, 250 spaced from the pole tip and gap region 180. In sequence step 342, the mask 340 is removed and in sequence step 344, the front shield deposition 256 is deposited over the etched first and second gap depositions 244, 250 to form top portions of the side shield structure and the front shield structure 174. Illustratively, the front shield deposition 256 is electro-plated to the side shield structure and gap deposition 250 via a conductive seed layer (not shown).

FIG. 4C illustrates another embodiment for a box shield structure utilizing the process steps of FIG. 4A, where like numbers are used to refer to like parts in the previous FIGS. As previously described in FIG. 3C, the deposition stack for the box shield structure includes the bottom shield layer 260 as shown in sequence step 350 of FIG. 4C to form the leading shield structure. In sequence step 352 the side shield deposition 222 is deposited on the pole tip structure 210 including the bottom shield layer 260 to form the box shield structure. As previously described, the side shield deposition 222 is deposited on a conductive seed layer on the pole tip structure 210. Similar to FIG. 4B, in step 354, stop layer 232 is deposited on the side shield deposition 222 and mask 236 is patterned on the stop layer 232 to etch the side shield deposition 222 to form the recessed edge surface 237 uptrack from the trailing edge 172 of the pole tip as illustrated in sequence step 356.

In step 358, the first gap deposition 244 is deposited and planarized as shown in step 360 utilizing the stop layer 232. In step 362, the second gap deposition 250 is deposited. In sequence step 364, mask 340 is patterned to etch the first and second gap depositions 244, 250 as shown in sequence step 368. In sequence step 370, the front shield deposition 256 is deposited on the etched side shield deposition 222 to form a top portion of the side shield structure and the front shield structure 174 as previously described.

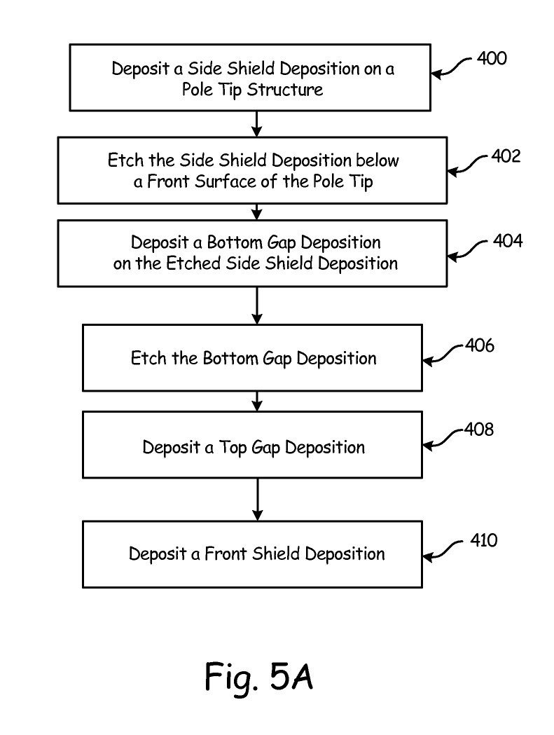

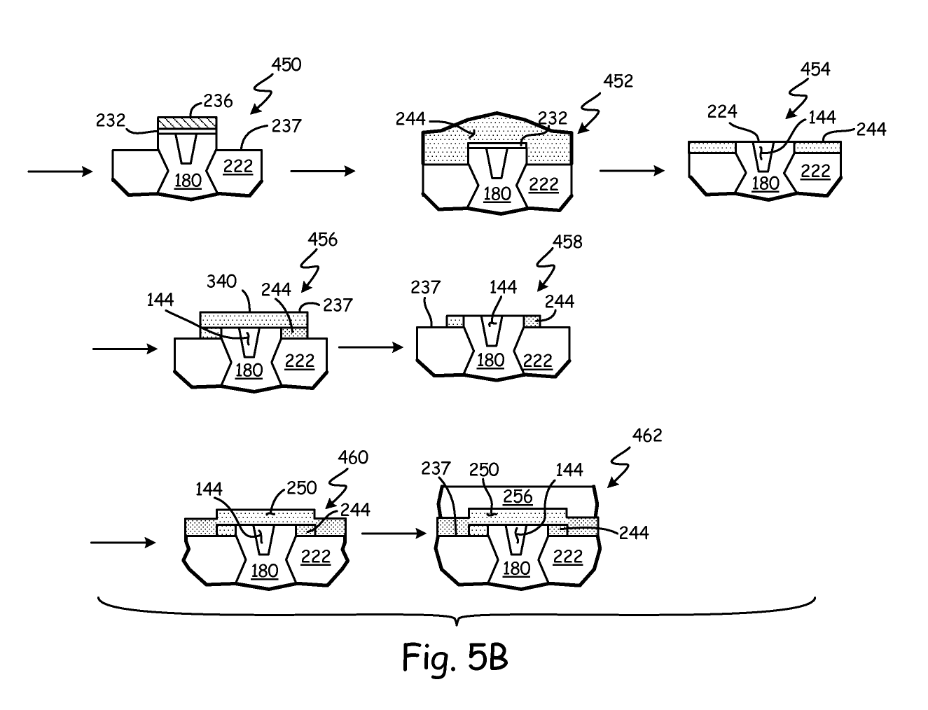

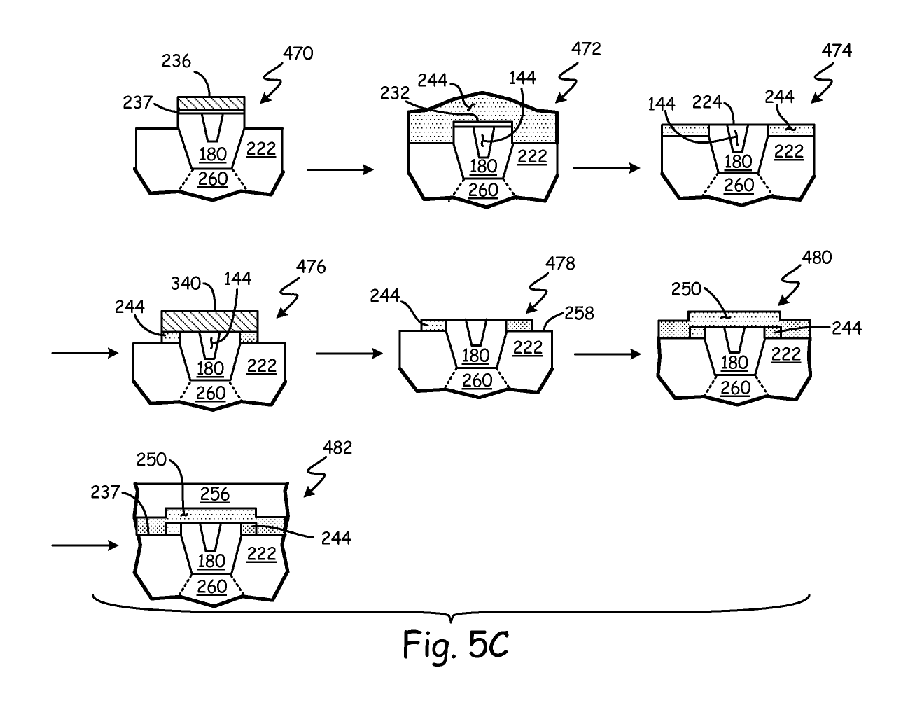

FIG. 5A illustrates another embodiment for fabricating the shield structure for the pole tip 144 of the write element 140. As illustrated in FIG. 5A, in step 400 the side shield deposition 222 is deposited on the pole tip structure 210 as previously described. In step 402, the side shield deposition 222 is etched to form the trailing edge surface 237 of the side shield structure recessed below the front surface 224 of the pole tip 144. In step 404, a bottom or first gap deposition 244 is deposited on the etched side shield deposition 222. In step 406, portions of the first gap deposition 244 are etched. In step 408 a top or second gap deposition 250 is deposited. In step 410 the front shield deposition 256 is deposited over the top or second gap deposition 250 to form the front shield structure 174 of the write element 140 separated from the pole tip 144 via write gap 175 formed by the second gap deposition 250.

FIG. 5B illustrates embodiments utilizing the process steps described in FIG. 5A. As previously described, the side shield deposition 222 is deposited on the pole tip structure 210 formed by the etched deposition stack and gap layer. In sequence step 450, the side shield deposition 222 is etched using the patterned mask 236 to form a trailing edge surface 237 recessed below the front surface 224 of the pole tip 144 as previously described in other embodiments. In sequence steps 452, 454, the first gap deposition 244 is deposited and planarized utilizing the stop layer 232 as previously described. In sequence step 456, the first gap deposition 244 is etched using mask 340 to remove outer portions of the deposition 244 to form the extended gap region. The mask 340 is removed in sequence step 458 and in step 460, the second gap deposition 250 is deposited over the first gap deposition 244 and outer portions of the side shield deposition 222. In sequence step 462, the front shield deposition 256 is deposited to form the front shield structure 174 as previously described.

FIG. 5C illustrates a box shield embodiment utilizing the process steps described in FIG. 5A. In FIG. 5C, the side shield deposition 222 is deposited on the pole tip structure 210 etched from a deposition stack including the bottom shield layer 260 as previously described with respect to FIG. 3C. Similar to FIG. 5B, in sequence step 470, the side shield deposition 222 is etched using the patterned mask 236 to form the trailing edge surface 237 recessed below the front surface 224 of the pole tip 144 as previously described in other embodiments. In sequence steps 472, 474, the first gap deposition 244 is deposited and planarized. In sequence step 476, the first gap deposition 244 is etched using mask 340. The mask 340 is removed in sequence step 478 and in sequence step 480, the second gap deposition 250 is deposited. Thereafter in step 482, the front shield deposition 256 is deposited to form the front shield structure 174, write gap 175 and extended gap region as previously described.

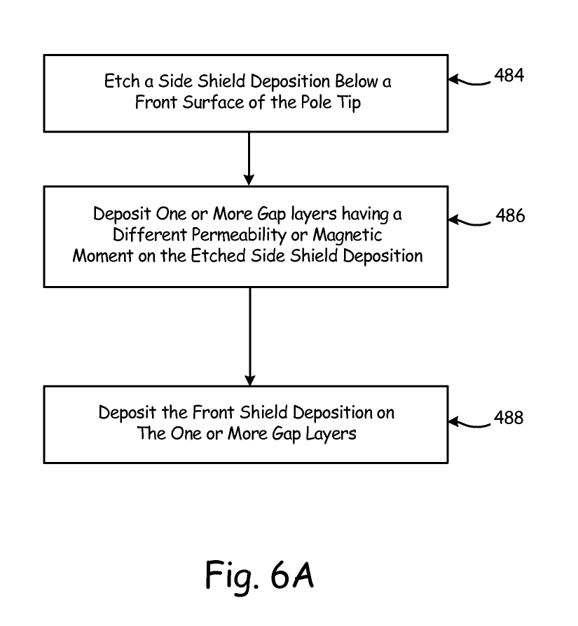

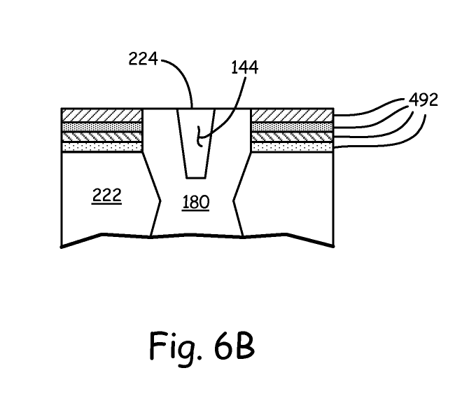

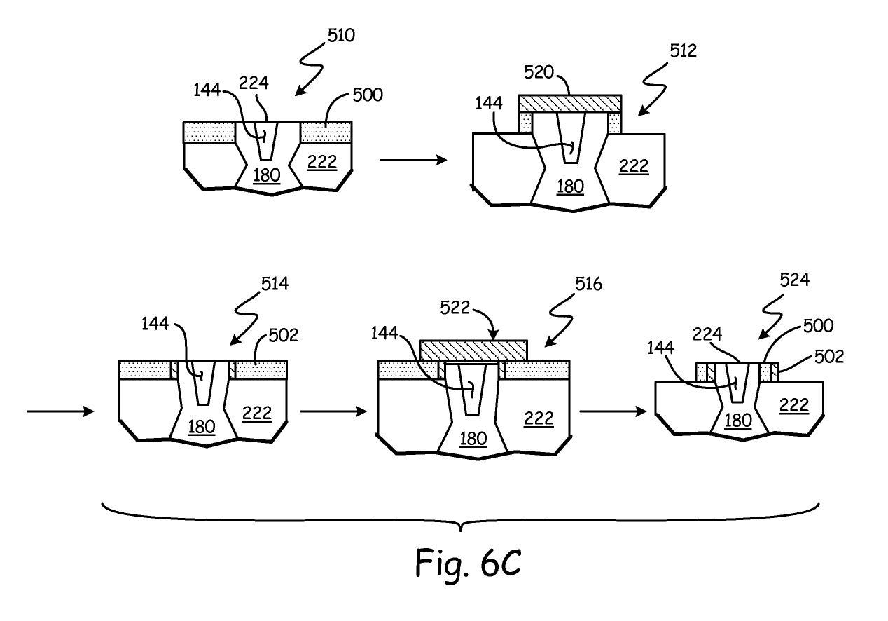

FIG. 6A illustrates another embodiment for fabricating the shield structure for the pole tip 144 separated from the pole tip 144 via a gap region having a graded magnetic structure formed of a graded magnetic moment material. FIG. 6A illustrates fabrication steps for fabricating the graded magnetic structure for the gap region. As shown in step 484, the side shield deposition 222 is etched below the front surface 224 of the pole tip 144 as previously described with respect to the embodiments disclosed in FIGS. 3B-3C, FIGS. 4B-4C and FIGS. 5B-5C. In step 486, gap deposition 244 is deposited on the etched side shield deposition 222. Deposition of the gap deposition 244 includes deposition of multiple different layers having different material compositions to provide the graded magnetic moment gap structure providing a differential shielding effect along the trailing portion of the pole tip 144. Thereafter in step 488, the front shield deposition 256 is deposited to form the front shield structure 174 for the pole tip 144 as previously described.

In illustrative embodiments, the layers of the graded gap structure are formed of ferromagnetic alloy materials such as cobalt iron CoₓFe_{y}, iron nickel Fe_{y}Niₓ cobalt iron nickel CoₓFe_{y}Ni_{z} and the percentages of x, y, and/or z of one or more of the alloy elements is varied along the length or width of the extended gap region or write gap 175 to provide the graded magnetic moment material having a graded saturation magnetization Ms to limit flux leakage to the side shield structure 176, 178 proximate to the trailing edge 172 of the pole tip 144 .

FIG. 6B illustrates an embodiment utilizing the process steps described in FIG. 6A. As previously described, the side shield deposition 222 is etched to a height recessed below the front surface 224 of the pole tip 144. As shown, multiple gap layers 492 are sequentially deposited to form the gap deposition 244 along the etched side shield deposition 222 utilizing for example, a chemical vapor deposition process. The multiple gap layers 492 have different material compositions to provide the graded magnetic moment structure along the trailing portion of the pole tip 144. The different material compositions have different magnetic permeability or different magnetic moments. For example, the layers 492 are arranged so that the permeability or magnetic moment decreases in the downtrack direction to reduce flux leakage proximate to the trailing edge 172 of the pole tip 144.

In FIG. 6C, multiple gap layers 500, 502 are orientated lengthwise and are spaced in a cross-track direction. The multiple gap layers 500, 502 of the extended gap are formed via sequential deposition and etching steps 510, 512, 514, 516 as progressively illustrated in FIG. 6C. In particular, in step 510, layer 500 is deposited and etched via mask 520 in step 512. Layer 502 is deposited and planarized in step 514, and etched in step 516 via mask 522 as illustrated in sequence step 524. The process of depositing the gap layer and etching the gap layer is repeated based upon design criteria of the graded structure and size of the extended gap region. Each of the multiple layer gap depositions or structures can be utilized to form the gap region for the previous embodiments illustrated in FIGS. 3B-3C, 4B-4C and 5B-5C, however application is not limited to the embodiments shown in FIGS. 3B-3C, 4B-4C and 5B-5C.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application while maintaining substantially the same functionality without departing from the scope and spirit of the present invention. In addition, although the embodiments described herein are directed to particular examples it will be appreciated by those skilled in the art that the teachings of the present invention are not limited to the particular examples and other embodiments can be implemented without departing from the scope and spirit of the present invention.

What is claimed is:

1. A method comprising:
etching a side shield deposition to a depth recessed below a front edge surface of a pole tip;
depositing a gap deposition on the etched side shield deposition; and
depositing a front shield deposition on the gap deposition to form a front shield structure along the front edge surface of the pole tip.

2. The method of claim 1 and comprising:
etching a deposition stack including an insulating layer and pole tip layer and depositing a gap layer to form a pole tip structure including the pole tip;
and depositing the side shield deposition on the pole tip structure utilizing a conductive seed layer.

3. The method of claim 1 wherein the step of depositing the gap deposition comprises:
depositing a first gap deposition;
planarizing the first gap deposition to remove a portion of the first gap deposition above the front edge surface of the pole tip; and
depositing a second gap deposition to form a write gap between the pole tip and the front shield structure.

4. The method of claim 3 and comprising
utilizing a stop layer to control a planarization depth of the first gap deposition along the front edge surface of the pole tip region.

5. The method of claim 3 wherein the first and second gap depositions are fabricated from the same non-magnetic insulating material.

6. The method of claim 4 and comprising:
depositing the stop layer over the side shield deposition and pole tip region prior to etching the side shield deposition to the recessed depth.

7. The method of claim 3 comprising
etching portions of the first and second gap depositions deposited on the side shield deposition prior to depositing the front shield deposition.

8. The method of claim 7 and comprising;
applying a mask to a pole tip region and utilizing the mask to etch the portions of the first and second gap depositions outwardly from the pole tip region.

9. The method of claim 3 and comprising:
etching the first gap deposition prior to depositing the second gap deposition; and
depositing the front shield deposition on the second gap deposition.

10. The method of claim 1 wherein the step of depositing the gap deposition comprises:
depositing multiple different gap layers having different material compositions to form a graded extended gap region for the pole tip.

11. A method comprising:
etching a side shield deposition to form a trailing edge surface of a side shield structure recessed below a front surface of a pole tip;
depositing a first gap deposition on the trailing edge surface of the side shield structure below the front surface of the pole tip;
depositing a second gap deposition over the first gap deposition; and
depositing a front shield deposition on the second gap deposition to form a front shield structure and write gap between the front surface of the pole tip and the front shield structure.

12. The method of claim 11 wherein the side shield deposition is etched to a recessed depth to form the trailing edge surface proximate to a midpoint of the pole tip between a leading edge and trailing edge of the pole tip.

13. The method of claim 11 wherein the side shield deposition is etched to a recessed depth greater than at least a third of the pole tip height measured from a leading edge to a trailing edge of the pole tip.

14. The method of claim 11 and comprising the steps of :
etching one or both of the first and second gap depositions prior to depositing the front shield deposition.

15. The method of claim 11 and comprising:
etching the first gap deposition prior to depositing the second gap deposition; and
depositing the second gap deposition over the first gap deposition and portions of the etched side shield deposition.

16. A method comprising:
depositing a side shield deposition along a gap layer separating the side shield deposition from side edges of a pole tip;
etching the side shield deposition below a front surface of the pole tip;
depositing a gap deposition on an etched surface of the side shield deposition;
etching portions of the gap deposition to form an extended gap region; and
depositing a front shield deposition to form the front shield structure downtrack of the pole tip.

17. The method of claim 16 wherein the gap deposition is a first gap deposition and comprising:
depositing a second gap deposition on the first gap deposition; and
depositing the front shield deposition on the second gap deposition.

18. The method of claim 16 wherein the gap deposition is a first gap deposition and prior to etching the first gap deposition comprising:
depositing a second gap deposition; and
etching both the first and second gap depositions to form the extended gap region.

19. The method of claim 16 wherein the step of etching the side shield deposition comprises etching the side shield deposition to a mid-point of the pole tip prior to depositing the gap deposition.

20. The method of claim 17 wherein the first and second gap depositions are formed of the same material.
